(19) United States
(12) Patent Application Publication
(10) Pub. No.: US 2026/0215461 A1
(43) Pub. Date: Jul. 30, 2026

(54) POWDERED BEVERAGE DELIVERY PRODUCT AND METHOD OF MAKING A POWDERED BEVERAGE DELIVERY PRODUCT

(71) Applicant: Kraft Foods Group Brands LLC, Chicago, IL (US)

(72) Inventor: Alexander William Smith, Glenview, IL (US)

(21) Appl. No.: 19/144,242

(22) PCT Filed: Dec. 19, 2023
(86) PCT No.: PCT/US2023/084753

§ 371 Date: Jun. 27, 2025

Related U.S. Application Data
(60) Provisional application No. 63/436,139, filed on Dec. 30, 2022.

(51) Int. Cl. A23L 2/39; A23L 2/38; A23L 2/56; A23L 2/58; A23L 2/60; A23L 2/68

(52) U.S. Cl. CPC A23L 2/39; A23L 2/38; A23L 2/56; A23L 2/58; A23L 2/60; A23L 2/68

(57) ABSTRACT

An example powdered beverage delivery product includes an edible carrier body and a beverage powder coated on the carrier body. The carrier body may be, for example, a starch carrier or a marbit carrier. The beverage powder is soluble in water. The powdered beverage delivery product may be prepared by a method comprising applying an aqueous liquid to a carrier and applying a beverage powder to the carrier body to make the powdered beverage delivery product.

### FIELD

This application relates generally to powdered beverage delivery products.

### BACKGROUND

Flavored beverages are widely accepted by consumers and have increased in popularity in recent years. Flavored beverages are often prepared at home using powdered drink mixes, including commercially-available products like TANG®, CRYSTAL LIGHT®, and KOOL-AID® from Kraft Foods, to provide beverages in a variety of flavors, including fruit and tea flavors. Some drink mixes require the consumer to add sweetener, typically sucrose, when preparing the beverage. Other products that include sucrose often necessitate that relatively large amounts of the product be used to prepare each beverage.

Some of these commercially available powdered drink mixes include the use of sachets or canisters. Opening the sachet and depositing the powdered beverage into a beverage vessel can be messy. Measuring out the powdered beverage from a canister and transferring it into a beverage vessel can also be messy. Consumers may also find the measuring process to be slow and inconvenient. Additionally, the sachets and canisters themselves create waste. Some commercially available powdered beverage delivery mechanisms include the use of tablets. Tables may be slow to dissolve. Additionally, tablets involve the use of effervescence, which some consumers, including children, may dislike.

### BRIEF DESCRIPTION OF THE DRAWINGS

FIG. 1 is a photograph of example powdered beverage delivery products.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Described herein is a powdered beverage delivery product. The powdered beverage delivery product includes an edible carrier body and a beverage powder coated thereon, and may be used to make a beverage, such as a single serving beverage. The beverage powder may include one or more of an acidulant, a flavor ingredient, a colorant, or a sweetener. The edible carrier body may also include one or more of a flavor ingredient, a colorant, or a sweetener in addition to the ingredient that generally creates the structure of the carrier body. A beverage may be made by placing the beverage delivery product in a beverage vessel containing an aqueous liquid (e.g., water). The beverage powder dissolves in the aqueous liquid to form the beverage. The edible carrier body may be formulated to dissolve in the aqueous liquid or to remain in the beverage. Further, the edible carrier body may be formulated to float in the beverage or to be denser than the aqueous liquid. The consumer experience using the beverage delivery product to make a beverage may be faster, simpler, and less messy than the consumer experience with sachets, canisters, or tablets.

In one approach, the powdered beverage delivery product includes: an edible carrier body; and a beverage powder coated on the edible carrier body, the beverage powder having a solubility in water of at least 0.5 grams, at least 1 gram, or at least 2 grams, in 500 grams of water at 40° F. The beverage powder should dissolve in water at 40° F. in less than 2 minutes, in less than 1 minute, or less than 30 seconds.

In one approach, the powdered beverage delivery product includes: an extruded carrier body, such as an extruded starch carrier body; and a beverage powder coated on the extruded carrier body, the beverage powder having a solubility in water of at least 0.5 grams, at least 1 gram, or at least 2 grams, in 500 grams of water at 40° F. The beverage powder should dissolve in water at 40° F. in less than 2 minutes, in less than 1 minute, or less than 30 seconds.

In another approach, the powdered beverage delivery product includes: a slowly or non-dissolving carrier body, such as a marbit carrier; and a beverage powder coated on the carrier body, the beverage powder having a solubility in water of at least 0.5 grams, at least 1 gram, or at least 2 grams, in 500 grams of water at 40° F. As used herein, a slowly or non-dissolving carrier body is one that does not dissolve within 15 minutes at 40° F.

The powdered beverage delivery product may be provided in any desirable shape. The three-dimensional shape of the product is not particularly limited. However, the powdered beverage delivery product is specifically not in a shape that would be considered a powder or granular particulate. In some aspects, the powdered beverage delivery product is not in the shape of a flake. In some examples, the powdered beverage delivery product may be in any three-dimensional shape, such as the shape of a ball, bar, star, flower, heart, bean, sphere, cylinder, cube, cuboid, or the like, with the overall shape of the powdered beverage delivery product being driven by the shape of the edible carrier body.

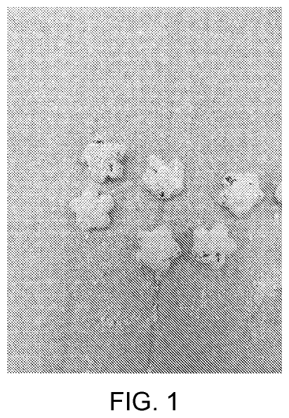

An exemplary powdered beverage delivery product is shown in FIG. 1 having a star shape.

The powdered beverage delivery product may any desirable length, width, and depth (thickness). In some examples, the powdered beverage delivery product has a smallest dimension of at least 0.2 cm, at least 0.3 cm, at least 0.4 cm, at least 0.5 cm, or in another aspect at least 0.6 cm. In some examples, the larger dimensions may be at least about 0.5 cm, at least about 1 cm, at least about 1.5 cm, or at least about 2 cm. In some examples, one or both of the larger dimensions of the powdered beverage delivery product may be about 0.5 cm to about 6 cm, about 0.5 cm to about 5.5 cm, about 0.75 cm to about 5.5 cm, about 1 cm to about 5.5 cm, about 1 cm to about 5 cm, about 1 cm to about 4.5 cm, and about 1.5 cm to about 4 cm.

In some approaches, the powdered beverage delivery product has a size such that a consumer is able to pick it up with their fingers and place it in a beverage vessel. The maximum size of the powdered beverage delivery product is not particularly limited other than to provide a size that may be placed within a beverage vessel and allow for the beverage to be consumed without interference by the powdered beverage delivery product.

The powdered beverage delivery product may be any desirable weight. In some examples, the powdered beverage delivery product a weight of at least about 1 gram, at least about 2 grams, at least about 3 grams, about 1 grams up to about 100 grams, about 1 grams up to 50 grams, about 1 gram up to about 30 grams, or about 1 gram up to about 20 grams, about 1 gram up to about 10 grams, or about 1 gram up to about 5 grams.

In some aspects, the powdered beverage delivery product is substantially free from oil. If the powdered beverage delivery product were to contain oil, when the powdered beverage delivery product is used to make a beverage, the oil may form an oil layer on the beverage. Such an oil layer may be undesirable to consumers. For purposes herein, substantially free of oil means less than 0.5 wt % oil, in another aspect less than 0.25 wt %, in another aspect 0 wt %, based on the weight of the powdered beverage delivery product. At least in some approaches, trace amounts of oil may be included, such as in the form of flavoring ingredients, without adversely affecting the performance of the product.

In some aspects, the powdered beverage delivery product may effervesce in the presence of water. As used herein, the term “effervesce” refers to the forming of gas bubbles, such as carbon dioxide bubbles, when placed in a liquid (such as water). As such, in some examples, the powdered beverage delivery product includes one or more ingredients, such as sodium or potassium bicarbonate, that effervesce in the presence of acid and water. However, in other approaches, the powdered beverage delivery product may be formulated so that it does not effervesce when added to the aqueous liquid to form the beverage.

### Edible Carrier Body

The powdered beverage delivery product includes an edible carrier body. The edible carrier body acts a vehicle for delivery of the beverage powder to the aqueous liquid for forming the beverage. As such, the carrier body is able to be coated with the beverage powder. The carrier body also gives the powdered beverage delivery product its shape. As such, the carrier body may be formed into the any shape desired for the powdered beverage delivery product (e.g., a ball, bar, star, flower, heart, bean, sphere, cylinder, cube, cuboid, or the like). The carrier body is formed of ingredients that are edible. The carrier body may be formed of one or more ingredients that dissolve upon delivery to the aqueous liquid or may be formed of one or more ingredients that remain largely undissolved upon delivery to the aqueous liquid. As used herein, dissolvability is in reference to addition to an aqueous liquid at 40° F. In one approach, the carrier body dissolves in water at 40° F. in less than 2 minutes, in less than 1 minute, or less than 30 seconds (wherein the mass of water in which the carrier is dispersed in is at least 100 times greater (e.g., 5 grams of carrier body dispersed in 500 grams water)). In some aspects, the starch carrier is in the form of an extruded puff. In these aspects, starch carrier may be formed by extrusion (e.g., screw extrusion).

In some examples, the edible carrier body comprises a starch carrier body. The ingredients of the starch carrier body may be selected so that it dissolves in the aqueous liquid when the powdered beverage delivery product is used to make a beverage.

In some approaches, the starch carrier body has a solubility in water of at least 0.5 grams, at least 1 gram, at least 2 grams, at least 3 grams, 0.5 gram to 4 grams, 1 gram to 4 grams, 1 gram to 3.5 grams, or about 1.5 to about 3.5 grams, in 500 grams of water at 40° F. In these approaches, the starch carrier dissolves in the aqueous liquid when the powdered beverage delivery product is used to make a beverage. In one approach, the starch carrier body dissolves in water at 40° F. in less than 2 minutes, in less than 1 minute, or less than 30 seconds.

In some examples, the starch carrier body comprises a starch, such as at least 80 wt % starch by weight of the carrier body. For preparing a fast-dissolving carrier body, suitable starches include, for example, tapioca starch, cornstarch, and potato starch. These starches dissolve quickly in aqueous liquid at 40° F. In some approaches, the starch carrier comprises about 80 wt % to 100 wt % starch. In other approaches, the starch carrier comprises about 80 wt % to about 90 wt % starch and up to 20 wt % polydextrose, in another aspect 10 wt % to about 20 wt % polydextrose, based on the total weight of the starch carrier body. If desired, the starch carrier body may further comprise other components, such as sweeteners, colorants, and flavor ingredients.

If a slower dissolving or non-dissolving carrier body is needed, ingredients of lesser water solubility may be used in place of the starch. For example, a carrier body comprising one or more of rice starch, whole wheat flour, and wheat starch may be used to form a slow or non-dissolving carrier body.

In other approaches, the edible carrier body does not dissolve within 15 minutes in water at 40° F. In these approaches, the edible carrier body remains in the aqueous liquid when the powdered beverage delivery product is used to make a beverage. Edible carrier bodies that remain in the beverage may float on top of the beverage (i.e., the carrier body has a density less than the density of the beverage), sink to the bottom of the beverage (i.e., the carrier body has a density greater than the density of the beverage), or stay in the middle of the beverage (i.e., the carrier body has a density equal to the density of the beverage).

In some examples, the slowly or non-dissolving carrier body comprises a marbit carrier. As used herein, the term “marbit” refers to a dehydrated marshmallow. In these approaches, the marbit carrier remains in the aqueous liquid when the powdered beverage delivery product is used to make a beverage. Marbit carriers that remain in the beverage may float on top of the beverage (i.e., the marbit carrier has a density less than the density of the beverage), sink to the bottom of the beverage (i.e., the marbit carrier has a density greater than the density of the beverage), or stay in the middle of the beverage (i.e., the marbit carrier has a density equal to the density of the beverage). In some examples, the marbit carrier includes one or more of sugar, corn syrup, and gelatin.

The powdered beverage delivery product further includes a beverage powder. The beverage powder dissolves in the aqueous liquid when the powdered beverage delivery product is used to make a beverage. It has been unexpectedly found that the beverage powder readily dissolves off of the carrier. In some examples, the beverage powder dissolves off of the carrier in less than 2 minutes, in less than 1 minute, or less than 30 seconds of the powdered beverage delivery product being placed in water at 40° F.

The beverage powder is coated on the carrier body. The beverage powder being coated on the carrier body enables the beverage powder to dissolve in the aqueous liquid when the powdered beverage delivery product is used to make a beverage. The beverage powder is not encapsulated by the carrier.

In some examples, the beverage powder may be coated on the carrier so that it covers all or substantially all (e.g., more than 90%) of the surface area of the carrier. In other examples, the beverage powder may be coated on the carrier so that it covers a portion of the carrier.

The beverage powder may provide a flavor and/or color to the beverage. As such, in some examples, the beverage powder comprises one or more of a colorant and a flavor. In some aspects, the beverage powder includes about 50 wt % to about 90 wt % acid component, 0 wt % to about 12 wt % buffer (in another aspect about 1 wt % to about 12 wt % buffer), and about 1 wt % to about 30 wt % flavor, based on the total weight of the beverage powder. In some aspects, the beverage powder may further include a sweetener, such as about 1 to about 50 wt % sweetener, about 2 to about 30 wt % sweetener, or about 1 to about 10 wt % sweetener, based on the total weight of the beverage powder. In some aspects, the beverage powder may further include a colorant, such as less than about 2 wt % colorant, based on the total weight of the beverage powder.

In some approaches, the acid component may include any food grade acid, such as citric acid, malic acid, or a combination thereof. In some approaches, the buffer component may include, for example, potassium citrate, sodium citrate, tripotassium citrate monohydrate, or a combination thereof.

Additionally or alternatively, in some examples, the beverage powder comprises one or more of a sweetener, including nutritive (i.e., caloric sweeteners), such as sucrose, dextrose, and fructose, sugar alcohol, such as erythritol, and/or high intensity sweeteners, such as, for example, monatin, luo han guo (monkfruit), cyclamates (such as sodium cyclamate), acesulfame potassium, aspartame, cyclamates, sucralose, alitame, saccharine, neohesperidin dihydrochalcone, neotame, N—[N-[3-(3-hydroxy-4-methoxyphenyl) propyl]-L-a-aspartyl]-L-10 phenylalanine 1-methyl ester, N—[N-[3-(3-hydroxy-4-methoxyphenyl)-3-methylbutyl]-L-aaspartyl]-L-phenylalanine 1-methyl ester, N—[N-[3-(3-methoxy-4-hydroxyphenyl) propyl]L-a-aspartyl]-L-phenylalanine 1-methyl ester, and salts thereof, and steviol glycoside sweeteners, such as rebaudioside A, rebaudioside B, rebaudioside C, rebaudioside D, rebaudioside E, rebaudioside F, dulcoside A, dulcoside B, rubusoside, stevia, stevioside, and steviolbioside, and combinations thereof.

In some aspects, the beverage powder includes about 1 wt % to about 50 wt % sweetener, based on the total weight of the beverage powder. For beverage powders including nutritive sweeteners such as sugar, larger amounts of the sweetener are generally needed. In contrast, for beverage powders including high intensity sweeteners, lower amounts of the sweetener are generally needed. In some aspects, the beverage powder includes about 50 wt % to about 90 wt % acid, based on the total weight of the beverage powder. In some aspects, the beverage powder includes about 1 wt % to about 12 wt % buffer, based on the total weight of the beverage powder.

Additionally or alternatively, in some examples, the beverage powder may further comprise one or more additional components, such as fruit extract, vegetable extract, polyphenols, lutein, vitamins, electrolytes, minerals, antioxidants, caffeine, or combinations thereof.

The powdered beverage delivery product may include a set amount of the beverage powder. In some aspects, the powdered beverage delivery product includes about 25 wt % to about 75 wt % carrier body and about 25 wt % to about 75 wt % beverage powder, in another aspect about 50 wt % to about 75 wt % carrier body and about 25 wt % to about 50 wt % beverage powder, in another aspect about 60 wt % to about 70 wt % carrier body and about 30 wt % to about 40 wt % beverage powder, based on the total weight of the powdered beverage delivery product.

One or more of the powdered beverage delivery products may be used to form the beverage. In some examples, a consumer may select the number of powdered beverage delivery products to use to make a beverage based on, at least in part, the amount of aqueous liquid used and the desired beverage flavor and/or color. As such, by using the powdered beverage delivery product, a consumer does not have to measure the beverage powder.

Also disclosed herein is a method of making the powdered beverage delivery product. In one approach, the method includes: applying an aqueous liquid to a formed starch carrier body; and applying a beverage powder to the formed starch carrier body to make the powdered beverage delivery product, the beverage powder having a solubility in water of at least 0.5 grams, at least 1 gram, or at least 2 grams, in 500 grams of water at 40° F. The beverage powder should dissolve in water at 40° F. in less than 2 minutes, in less than 1 minute, or less than 30 seconds.

In another approach, the method includes: applying an aqueous liquid to a formed carrier body, the formed carrier body being a starch carrier or a marbit carrier; and applying a beverage powder to the carrier to make the powdered beverage delivery product, the beverage powder having a solubility in water of at least 0.5 grams, at least 1 gram, or at least 2 grams, in 500 grams of water at 40° F. The beverage powder should dissolve in water at 40° F. in less than 2 minutes, in less than 1 minute, or less than 30 seconds.

In the method, it is to be understood that the powdered beverage delivery product, the formed carrier body, the beverage powder may each be as described above.

The method includes applying an aqueous liquid (e.g., water) to a formed starch carrier body. The aqueous liquid applied to the carrier body allows the beverage powder to stick to the carrier when applied. In some examples, the aqueous liquid may dissolve the outer portion of the carrier.

The aqueous liquid may be applied by any suitable means. In some approaches, the aqueous liquid, such as water, may be misted or sprayed onto the carrier body. In some approaches, the carrier may be shaken or moved while the aqueous liquid is applied. The method further includes combining a beverage powder with the moistened carrier bodies to coat the beverage powder on the carrier body to form the powdered beverage delivery product. When a plurality of coated carrier bodies are made at once, the method may further include shaking the carrier bodies and beverage powder to ensure that the carrier bodies do not stick together during the application process. Only a small amount of aqueous liquid is needed to render the surface of the carrier body sticky to retain the beverage powder on its surface. Applying too much aqueous liquid to the surface of the carrier body can result in the carrier body beginning to dissolve or disintegrate.

The beverage powder may be applied by any suitable means. In some approaches, the beverage powder may be applied by shaking the carrier and the beverage powder together. In some approaches, the beverage powder may be applied to the carrier by rolling the carrier through the beverage powder or dipping the carrier in the beverage powder. In some examples, the method of applying the beverage powder may be selected so that a set amount of the beverage powder is coated on the carrier.

In some aspects, the method further includes drying the powdered beverage delivery product, which can take place at room temperature (e.g., 70° F.) or at an elevated temperature to expedite the drying process.

In some approaches, the method may further include forming the carrier body. In some aspects, the method further includes forming the starch carrier body by screw extrusion. In other aspects, the starch carrier may be made by any suitable means. In some aspects, the marbit carrier may be made by any suitable means.

In some approaches, the method may further include making the beverage powder. The beverage powder may be made by any suitable means. In some aspects, the beverage powder may be made by mixing together beverage powder ingredients (e.g., one or more of a colorant, a flavor, a sweetener, citric acid, and potassium citrate).

To further illustrate the present disclosure, examples are given herein. It is to be understood that these examples are provided for illustrative purposes and are not to be construed as limiting the scope of the present disclosure.

### EXAMPLES

### Example 1

Examples of the powdered beverage delivery product were prepared.

The carrier body was a starch carrier body in the form of an extruded puff made by screw extrusion using a formula of 100% tapioca starch (Tate & Lyle).

The beverage powder had the general formula shown in Table 1, with the wt % of each ingredient that was used (based on the total weight of the beverage powder).

TABLE 1

| | Beverage Powder |
|---|---|
| Ingredient | (wt %) |
| Flavors | 4.18 |
| Colorants | 0.65 |
| Citric Acid Powder | 78.95 |
| Sweeteners | 6.35 |
| Tripotassium Citrate Monohydrate Powder | 9.87 |
| Total | 100.00 |

To prepare the example powdered beverage delivery products, the starch carrier bodies were placed in a 500 ml beaker. In the beaker, the starch carrier bodies were vigorously shaken and exposed to a mist of water for 5 seconds to apply an even coating of water to the starch carrier bodies. Then, the starch carrier bodies (about 1 or 2 at a time) were transferred to another 500 ml beaker that contained 30 g of the beverage powder. In the beaker, the starch carrier bodies and the beverage powder were vigorously shaken for 7 seconds to coat the starch carrier bodies with the beverage powder and make the example powdered beverage delivery products. The example powdered beverage delivery products were then dried at 120° F. for 6 hours.

One or two of the example powdered beverage delivery products were placed in a beaker of 500 ml water at 70° F. and mixed using a stir bar. Within a few seconds, the beverage powder dissolved into the water to form a beverage. The extruded carrier body also quickly dissolved.

### Example 2

Additional examples of the powdered beverage delivery product were prepared.

The carrier was a marbit carrier. The beverage powder had the general formula shown in Table 1 (shown above in Example 1).

The example powdered beverage delivery products were prepared as described above in Example 1.

Some of the example powdered beverage delivery products were placed in a beaker of 500 ml water and mixed using a stir bar. Within a few seconds, the beverage powder dissolved into the water to form a beverage. The beverage powder dissolved into the water to make a beverage, and the marbit carriers floated on top of the beverage.

It is to be understood that the ranges provided herein include the stated range and any value or sub-range within the stated range. For example, a range of about 5 wt % to about 15 wt % should be interpreted to include not only the explicitly recited limits of range of about 5 wt % to about 15 wt %, but also to include individual values, such as 6.35 wt %, 7.5 wt %, 10 wt %, 12.75 wt %, 14 wt %, etc., and sub-ranges, such as about 7 wt % to about 10.5 wt %, about 8.5 wt % to about 12.7 wt %, about 9.75 wt % to about 14 wt %, etc. Furthermore, when “about” is utilized to describe a value, this is meant to encompass minor variations (up to +/−10%) from the stated value.

All percentages and ratios are calculated by weight unless otherwise indicated. All percentages and ratios are calculated based on the total weight of the compound or composition unless otherwise indicated.

Reference throughout the specification to “an example,” “one example,” “another example,” “some examples,” “other examples,” and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

1. A powdered beverage delivery product comprising:
an edible carrier body; and
a beverage powder coated on the edible carrier body, the beverage powder having a solubility in water of at least 0.5 grams in 500 grams of water at 40° F.

2. The powdered beverage delivery product as defined in claim 1, wherein the powdered beverage delivery product has a weight of about 1 grams to about 20 grams.

3. (canceled)

4. The powdered beverage delivery product as defined in claim 1, wherein the powdered beverage delivery product does not effervesce in the presence of water.

5. The powdered beverage delivery product as defined in claim 1, wherein the edible carrier body dissolves in water at 40° F. in less than 2 minutes.

6. The powdered beverage delivery product as defined in claim 1, wherein the edible carrier body does not dissolve in water at 40° F. in less than 15 minutes.

7. The powdered beverage delivery product as defined in claim 1, wherein the edible carrier body comprises starch.

8. (canceled)

9. (canceled)

10. The powdered beverage delivery product as defined in claim 1, wherein the beverage powder comprises one or more of a flavor, colorant, sweetener, acid component, and buffer.

11. A method of making a powdered beverage delivery product, comprising:
applying an aqueous liquid to an edible carrier body; and
applying a beverage powder to the edible carrier body to make the powdered beverage delivery product, the beverage powder having a solubility in water of at least 0.5 grams in 500 grams of water at 40° F.

12. The method as defined in claim 11, further comprising drying the powdered beverage delivery product.

13. (canceled)

14. The method as defined in claim 11, wherein the powdered beverage delivery product has a weight of about 1 gram to about 20 grams.

15. (canceled)

16. The method as defined in claim 11, wherein the powdered beverage delivery product does not effervesce in the presence of water.

17. The method as defined in claim 11, wherein the edible carrier body dissolves in water at 40° F. in less than 2 minutes.

18. The method as defined in claim 11, wherein the edible carrier body does not dissolve in water at 40° F. in less than 15 minutes.

19. The method as defined in claim 11, wherein the edible carrier body comprises starch.

20. (canceled)

21. (canceled)

22. The method as defined in claim 11, wherein the beverage powder comprises one or more of a colorant, flavor, sweetener, acid component, and buffer.

23. A powdered beverage delivery product comprising:
a carrier body, the carrier body being a starch carrier or a marbit carrier; and
a beverage powder coated on the carrier body, the beverage powder having a solubility in water of at least 0.5 grams in 500 grams of water at 40° F.

24. The powdered beverage delivery product as defined in claim 23, wherein the powdered beverage delivery product has a weight of about 1 gram to about 20 grams.

25. (canceled)

26. The powdered beverage delivery product as defined in claim 23, wherein the powdered beverage delivery product does not effervesce in the presence of water.

27. (canceled)

28. The powdered beverage delivery product as defined in claim 23, wherein the beverage powder comprises one or more of a colorant, flavor, sweetener, acid component, and buffer.

29. (canceled)

30. (canceled)

31. (canceled)
